(19) United States
(12) Patent Application Publication
(10) Pub. No.: US 2010/0063645 A1
(43) Pub. Date: Mar. 11, 2010

(54) Load balancing based on user input

(76) Inventor: Stephen J. Brown, Woodside, CA (US)

Correspondence Address: LUMEN PATENT FIRM, 350 Cambridge Avenue, Suite 100, PALO ALTO, CA, 94306, US

(21) Appl. No.: 12/283,222

(22) Filed: Sep. 9, 2008

(51) Int. Cl. G06F 19/00

(52) U.S. Cl. 700/296

(57) ABSTRACT

Load balancing with user input is provided for a community of users having chargeable devices, such as plug-in electric or hybrid vehicles. The users of the community input user preferences, including a time frame for charging the chargeable device. User-specific charging properties, such as a time for charging and a rate of charging, are determined based on the user preferences. Since each user provides a time frame when their chargeable device is required, a utility manager is able to reduce the aggregate power demand by delaying when to charge the devices of the users who do not require the devices immediately. By controlling the charging properties of the users, a utility manager can decrease peak power demands and can balance the power consumption of the community with the supply available to the community.

### FIELD OF THE INVENTION

The invention relates generally to power management. More particularly, the present invention relates to power load balancing based on user inputs related to charging electric devices.

### BACKGROUND

Public utilities and other utility resource managers have the difficult and important task of allocating resources to balance supply and demand. Load balancing is particularly difficult for electric utilities because the electric power grid has limited or no power storage capabilities. Currently, the electric power grids are generally outdated and have not kept up with the population growth and corresponding power usage.

The difficulties of the electric power grids are evident during extreme weather conditions when heating or cooling places great demands on the power grid. The simultaneous power usage of consumers operating heating or cooling devices creates a power demand that exceeds the available supply. To mitigate this situation, an electric utility company typically implements rolling blackouts to reduce the demand or the electric utility company purchases additional energy from other suppliers to increase the power supply. However, rolling blackouts cause poor service to the customers of the utility company, discomfort to the energy consumers, and possible human casualties. In addition, energy purchased from other suppliers are typically expensive to the consumers and are from energy sources that further climate change, such as through emissions of carbon and other greenhouse gases.

Today, the electric utilities face an increasing strain due to the power usage of new power-hungry appliances and devices, such as plug-in vehicles. Similar to load balancing problems due to heating or cooling devices during extreme weather conditions, the simultaneous usage of these power-hungry devices can cause failures and difficulties for the electric utilities. Though unbalanced energy use, caused by heating and cooling, typically occur only during extreme weather conditions, new power-hungry devices can potentially cause daily problems. For example, many commuters driving plug-in electric or hybrid vehicles would arrive home and plug in their vehicles at approximately the same time. Generally, upon plugging in, the vehicles will immediately draw charge and the combined demand could exceed the available supply. This problem is likely to increase over time as plug-in vehicles gain popularity due to financial and climate change considerations.

The present invention addresses at least the difficult problems of power management and advances the art with load balancing based on user input.

### SUMMARY OF THE INVENTION

The present invention is directed to electric power load balancing for a community of users based on user input. Each user of the community has a chargeable device, such as a plug-in electric or hybrid vehicle. The users of the community are communicatively connected to a utility manager, such as through a communication network. The utility manager receives one or more user preferences from each of the users, wherein the user preferences are related to charging the chargeable device of the users. One of the user preferences includes a time frame for charging the chargeable device. The utility manager determines one or more charging properties for each of the users based on the received user preferences and transmits the charging properties to the users. The charging properties are related to the charging of the chargeable devices of the users and include a charge time, a charge rate, or any combination thereof. Preferably, the charging properties are transmitted to a recharging module for controlling the charging of the chargeable devices of one or more users.

In an embodiment, an input module is provided for allowing each user to input user preferences to be communicated to the utility manager. Optionally, the input module is initiated for a user by plugging in the chargeable device of the user. An aggregate power demand of the community is calculated based on the communicated user preferences. The charging properties of one or more users are based at least partially on the aggregate power demand, preferably to reduce the aggregate power demand. In an embodiment, the aggregate power demand and/or the charging properties are variable in time. In an embodiment, the aggregate power demand is compared with a supply of power for the community. The charging properties of one or more users are determined based on the comparison.

In an embodiment, the chargeable device of one or more users includes an energy storage device, such as a battery. In another embodiment, the chargeable device of one of the users has a required charging time, and the time frame user preference the user is greater than or equal to the required charging time of the chargeable device of the user.

The community of users of the present invention can include a building having multiple units, an apartment building, an office building, a retail development, a neighborhood, a housing development, an urban development, a suburban development, a district, a utility district, a city, a county, or any combination thereof.

### BRIEF DESCRIPTION OF THE FIGURES

The present invention together with its objectives and advantages will be understood by reading the following description in conjunction with the drawings, in which:

FIG. 1 shows an example of user-inputted time frame for charging a plug-in vehicle according to the present invention.

FIG. 2 shows an example of a community of users U₁-U_{N} connected to a utility manager UM for load balancing by controlling charging properties CP₁-CP_{N} based on user preferences UP₁-UP_{N} according to the present invention.

FIG. 3 shows an example of the modules for one of the users of the community shown in FIG. 2 and according to the present invention.

FIG. 4 shows a flow chart of an example process for balancing the load of the community undertaken by the utility manager according to the present invention.

FIG. 5 shows a flow chart of an example process undertaken by a user of the community according to the present invention.

### DETAILED DESCRIPTION OF THE INVENTION

Load balancing, particularly for electric power, is a daunting task. The introduction and popularization of appliances and devices that require a great deal of electric power, such as the plug-in electric or hybrid vehicle, creates an even greater demand on the electric power grid and furthers the difficulties with load balancing. The present invention is directed to load balancing in a community of users based on user inputs and preferences. More particularly, the present invention relies on the fact that power demands can be distributed in time as not all devices and users require power immediately.

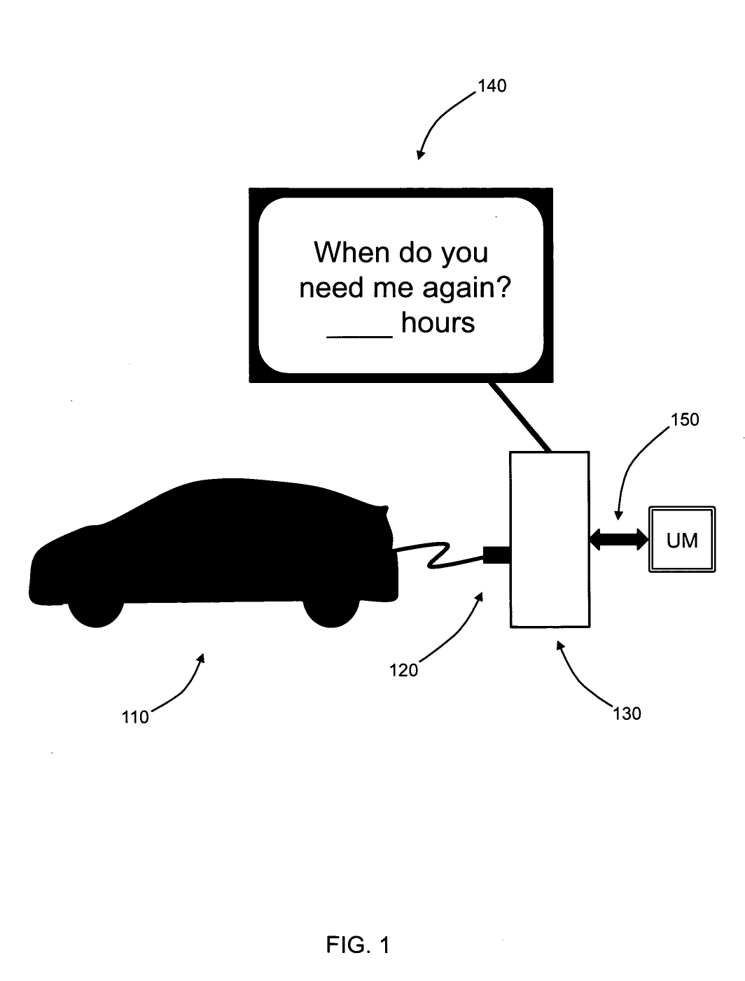

FIG. 1 shows an exemplary embodiment of the present invention for a user with a plug-in vehicle 110. An electrical connection 120 is made between the plug-in vehicle 110 and an outlet for providing electrical power to the plug-in vehicle 110. In an embodiment, a recharging module 130 controls the charging of the plug-in vehicle 110. The charging of the plug-in vehicle 110 is controlled using one or more charging properties, including a charge time, a charge rate, or any combination thereof.

It is important to note that FIG. 1 shows an input module 140 for the user to enter one or more user preferences related to the charging of the plug-in vehicle 110. In a preferred embodiment, one of the user preferences includes a time frame for charging the plug-in vehicle 110. For example, the input module 140 of FIG. 1 allows a user to input when the user will need the plug-in vehicle 110. In an optional embodiment, the input module 140 is initiated when the plug-in vehicle 110 is plugged into the outlet.

According to the present invention, the input module includes any mechanism known in the art for entering user preferences. In an embodiment, the input module can e a graphical user interface operable on a computing device, such as a computer, a personal digital assistant, a mobile phone, or a media player. In another embodiment, the input module includes an interface associated with the chargeable device, such as a user interface inside a plug-in vehicle. Alternatively or additionally, the input module can include a device specifically for inputting user preferences and located near the location where the chargeable device is plugged in.

It is also important to note that the user preferences are communicated to a utility manager UM. The user and the utility manager UM are communicatively connected 150, such as through a communication network. The utility manager UM can receive the user preferences, determine charging properties for the user, and transmit the charging properties to the user for controlling the charging of the plug-in vehicle 110.

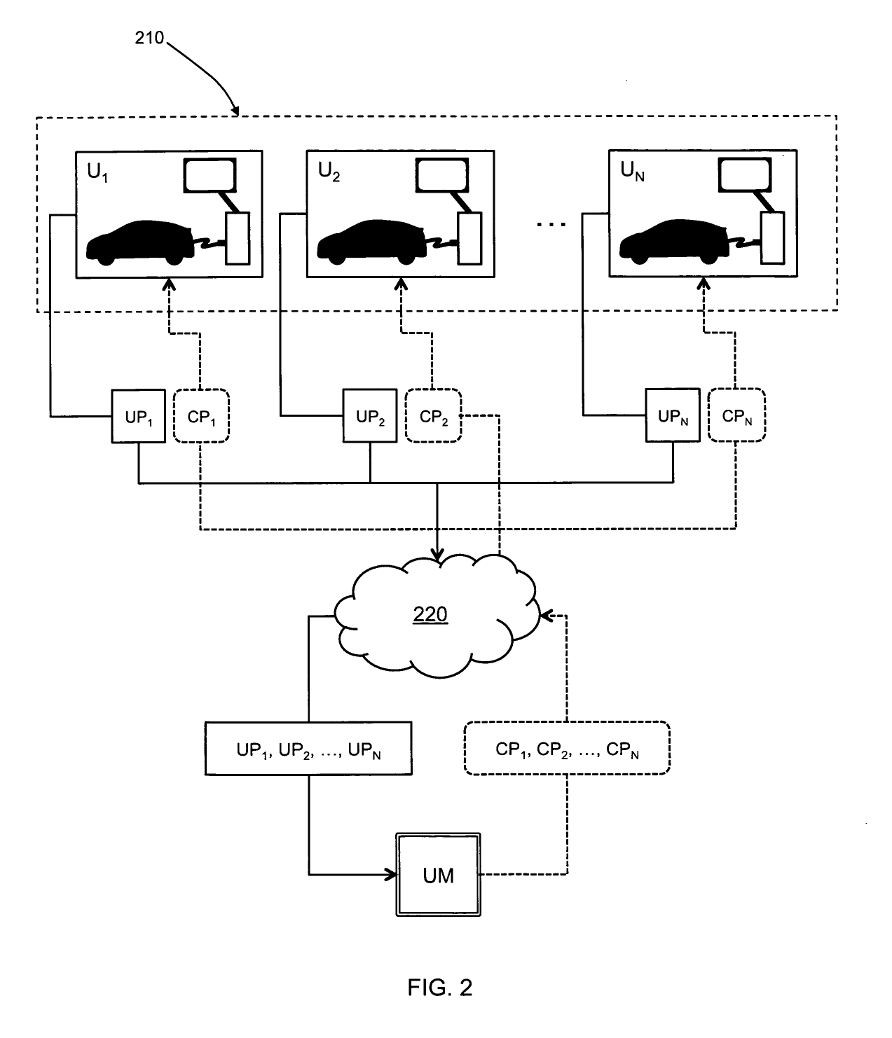

FIG. 2 shows a community 210 of users U₁-U_{N}, each of whom has a plug-in vehicle and modules shown in FIG. 1. The community 210 can include any group of users consuming an energy source, such as a building having multiple units, an apartment building, an office building, a retail development, a neighborhood, a housing development, an urban development, a suburban development, a district, a utility district, a city, a county, or any combination thereof. The users U₁-U_{N} of the community 210 are communicatively connected to a utility manager UM through a communication network 220, such as the Internet.

Users U₁-U_{N} of the community 210 transmit the user preferences UP₁-UP_{N} to the utility manager UM via the communication network 220. After receiving the user preferences, the utility manager UM can determine one or more user-specific charging properties CP₁-CP_{N} for each of the users U₁-U_{N}. The charging properties CP₁-CP_{N} can include a charge time, a charge rate, or any combination thereof. Charging properties CP₁-CP_{N} are then transmitted to the appropriate users U₁-U_{N}. As mentioned above, one of the user preferences UP₁-UP_{N} determined by the users U₁-U_{N} includes a time frame for charging the plug-in vehicle. A chargeable device, such as the plug-in vehicle, has a required charging time for charging the device to an appropriate level. Generally, the time frame inputted by a user is greater than or equal to the required charging time of the chargeable device of the same user.

Though FIGS. 1 and 2 show users U₁-U_{N} with plug-in vehicles 110, the present invention is directed to any chargeable or rechargeable device. The present invention is particularly directed to chargeable appliances and devices that require large amounts of electric power and that do not require continuous power. However, as is clear to one of ordinary skill in the art, the present invention is applicable to any electric device. Optionally, one or more of the chargeable devices of the users U₁-U_{N} includes an energy storage device, such as a battery. An energy storage device allows for increased flexibility to the charge time and charge rate.

The advantages of having user-specified preferences for charging electric devices can be made apparent by examples: Load balancing without user preferences for a community of energy consumers could potentially lead to catastrophic failures (e.g. blackouts due to excessive energy demand over supply) if many or all of the users are drawing power from the grid simultaneously. Failures would frequently occur if the users have devices that draw large amounts of power and the users have similar temporal patterns of power usage. This situation occurs for a community of commuters driving plug-in vehicles; since many commuters arrive home and plug in their vehicles at approximately the same time, the demand would peak at this time and potentially overload the grid.

The peak demands would be decreased or eliminated with the user preferences of the present invention. For the example of the community of commuters, since at least some of commuters will not require their vehicles until the next day, these commuters would enter a user preference of a long time frame before the vehicle will be needed. By receiving and knowing the time frames of the commuters, the utility manager can determine the appropriate charging properties to avoid overloading the grid. For example, if a plug-in vehicle of a user requires 2 hours to fully recharge and the user does not require the vehicle for the next 12 hours, power need not be delivered to the vehicle immediately. In this example, the utility manager can delay the delivery of power and only deliver power when the demand is low. Alternatively or additionally to adjusting the charging time for each user, the charging rate can be adjusted.

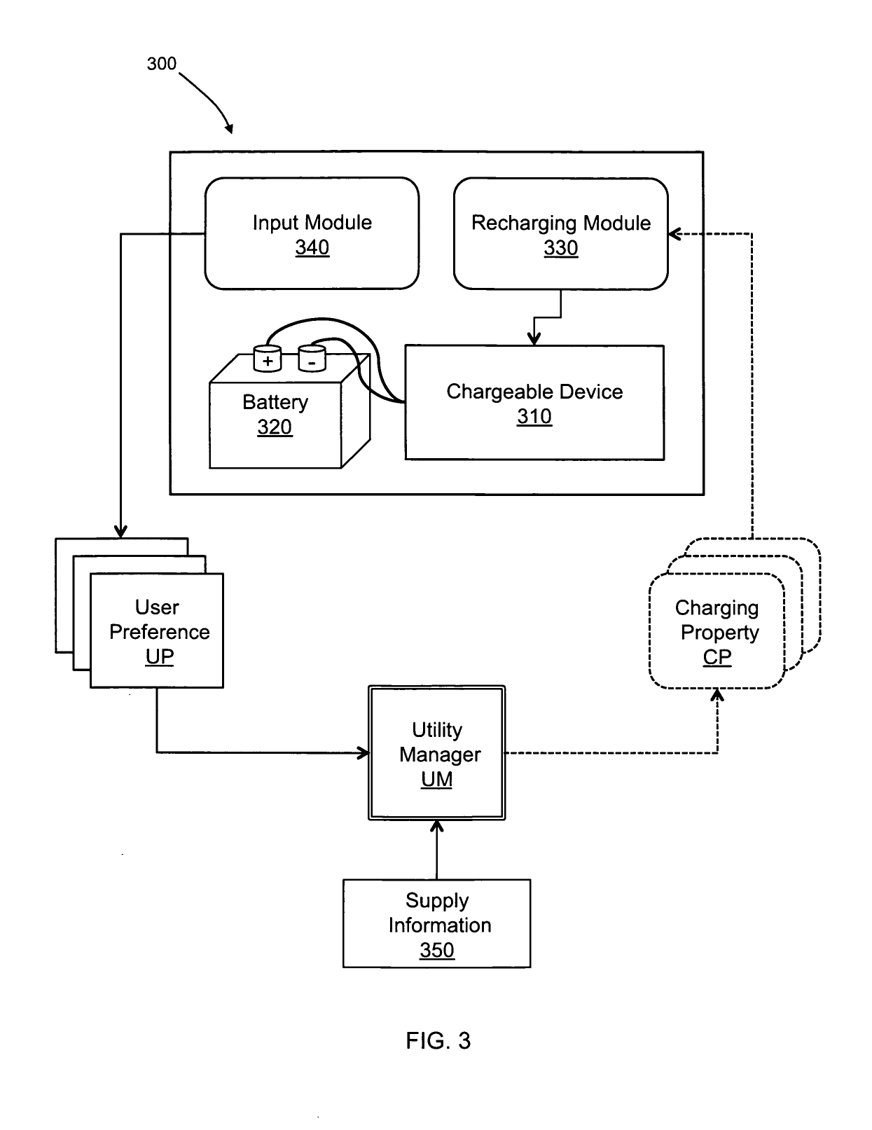

FIG. 3 shows details of the modules and devices of a user 300 in an embodiment of the present invention. The user 300 has a chargeable device 310 with a battery 320, an input module 320 for inputting user preferences UP, and a recharging module 330 to control the charging of the chargeable device 310. The user preferences UP are communicated to the utility manager UM. The utility manager UM receives and aggregates the user preferences UP of the users of the community and calculates an aggregate power demand for the entire community or a subset of the community. The aggregate power demand is calculated based at least partially on the received user preferences and can be variable in time.

The utility manager UM then determines charging properties CP for the user 300 based at least partially on the aggregate power demand of the community. Generally, the charging properties CP of the user 300 are preferably adjusted to reduce the aggregate power demand of the community. However, the charging properties CP of the user 300 can be adjusted for any other motive of the utility manager UM. The charging properties CP are transmitted to the recharging module 330 to control the charging of the chargeable device 310. FIG. 3 also shows the utility manager UM receiving or having supply information 350 related to the supply of power available to the community or to a subset of users of the community. In an embodiment, the utility manager UM compares the supply of power to the aggregate power demand and determines the charging properties CP based on the comparison.

Though FIG. 3 shows the recharging module 330 as belonging to user 300, in an embodiment the recharging module 330 is a centralized recharging module for controlling the charging of one or more chargeable devices of any number of users. For example, a centralized recharging module can be used to control the charging for all of the users of the community.

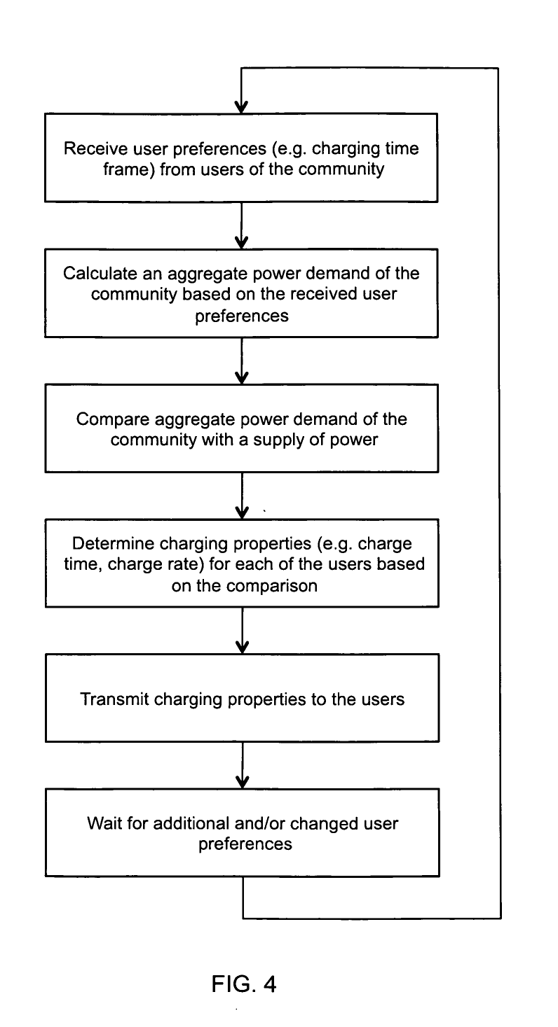

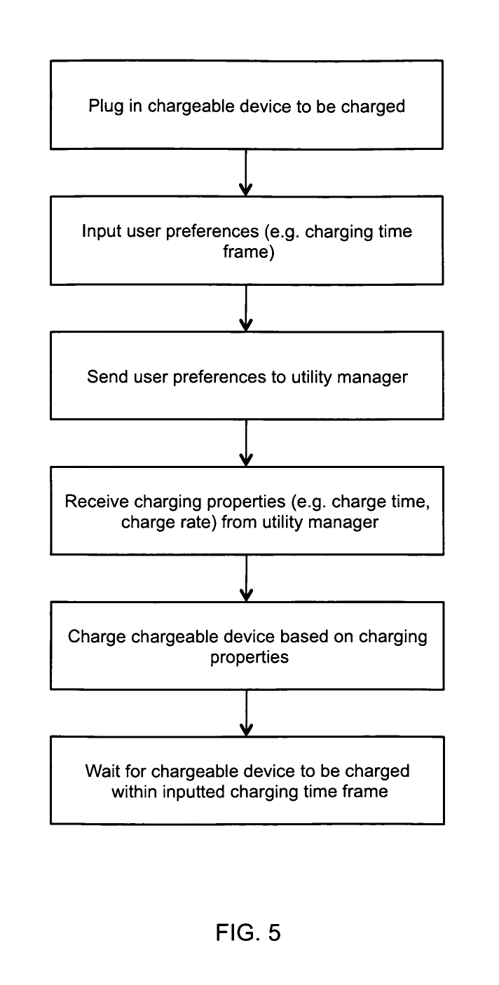

FIGS. 4 and 5 show flow charts of processes undertaken by a utility manager and a user of a community, respectively, according to an embodiment of the present invention. It is important to note that the charging properties for each user can be adjusted at any time by the utility manager to continuously balance the aggregate power demand with the available supply. In particular, charging properties can be adjusted based on additional user preferences provided by one or more users, changes to user preferences of one or more users, and/or changes to the supply of power.

As one of ordinary skill in the art will appreciate, various changes, substitutions, and alterations could be made or otherwise implemented without departing from the principles of the present invention, e.g. communication networks used to connect the users of the community to the utility manager can include a wireless network, a WAN, a LAN, a mobile phone network, a power line communication network, or any other communication network. Accordingly, the scope of the invention should be determined by the following claims and their legal equivalents.

What is claimed is:

1. In a community of a plurality of users, wherein each of said users has a chargeable device, a method for load balancing in said community comprising:
(a) receiving one or more user preferences from each of said users of said community, wherein said one or more user preferences are related to charging said chargeable device of the same of said users, and wherein one of said user preferences comprises a time frame for charging said chargeable device of the same of said users;
(b) determining one or more charging properties for each of said users of said community based on said received user preferences, wherein said charging properties are related to the charging of said chargeable device of the same of said users, and wherein said charging properties comprise a charge time, a charge rate, or any combination thereof; and
(c) transmitting said charging properties of each of said users to the same of said users.

2. The method as set forth in claim 1, wherein said chargeable device of at least one of said users comprises a plug-in vehicle.

3. The method as set forth in claim 1, further comprising aggregating said received user preferences and calculating an aggregate power demand of said community based on said received user preferences, wherein said charging properties of said users are based at least partially on said aggregate power demand of said community.

4. The method as set forth in claim 3, wherein said aggregate power demand is variable in time.

5. The method as set forth in claim 3, further comprising adjusting one or more of said charging properties of at least one of said users to reduce said aggregate power demand.

6. The method as set forth in claim 3, further comprising comparing a supply of power for said community to said aggregate power demand, wherein said charging properties of one or more users are based on said comparison of said supply of power and said aggregate power demand.

7. The method as set forth in claim 1, wherein said chargeable device of one or more of said users has a required charging time, and wherein said time frame user preference of one of said users is greater than or equal to said required charging time of said chargeable device of the same of said users.

8. The method as set forth in claim 1, further comprising providing an input module for allowing each of said users of said community to input said one or more user preferences.

9. The method as set forth in claim 8, wherein said input module is initiated by plugging in said chargeable device.

10. The method as set forth in claim 1, wherein said community comprises a building having multiple units, an apartment building, an office building, a retail development, a neighborhood, a housing development, an urban development, a suburban development, a district, a utility district, a city, a county, or any combination thereof.

11. A system for load balancing in a community, said system comprising:
(a) a plurality of users of said community, wherein each of said users has a chargeable device;
(b) an input module for allowing each of said users of said community to input one or more user preferences, wherein said one or more user preferences is related to charging said chargeable device of the same of said users, wherein one of said user preferences comprises a time frame for charging said chargeable device of the same of said users;
(c) a recharging module for controlling the charging of said chargeable devices of said users of said community, wherein the charging is associated with one or more charging properties, and wherein said charging properties comprise a charge time, a charge rate, or any combination thereof; and
(d) a utility manager communicatively connected to each of said users of said community, wherein said utility manager receives said user preferences from each of said users, wherein said utility manager determines one or more of said charging properties for each of said users based on said received user preferences, and wherein said charging properties are transmitted to said recharging module.

12. The system as set forth in claim 11, wherein said chargeable device of at least one of said users comprises a plug-in vehicle.

13. The system as set forth in claim 11, wherein said chargeable device of at least one of said users comprises an energy storage device.

14. The system as set forth in claim 10, wherein said utility manager aggregates said received user preferences and calculates an aggregate power demand of said community based on said received user preferences, and wherein said charging properties of each of said users are based at least partially on said aggregate power demand of said community.

15. The system as set forth in claim 14, wherein said aggregate power demand is variable in time.

16. The system as set forth in claim 14, wherein said charging properties of at least one of said users is for reducing said aggregate power demand.

17. The system as set forth in claim 14, wherein said utility manager compares a supply of power for said community to said aggregate power demand, and wherein said charging properties of one or more of said users are based on said comparison of said supply of power and said aggregate power demand.

18. The system as set forth in claim 11, wherein said chargeable device of one or more of said users has a required charging time, and wherein said time frame inputted by one of said users is greater than or equal to said required charging time of said chargeable device of the same of said users.

19. The system as set forth in claim 11, further comprising a communication network, wherein said users of said community and said utility manager are communicatively connected through said communication network.

20. The system as set forth in claim 11, wherein said community comprises a building having multiple units, an apartment building, an office building, a retail development, a neighborhood, a housing development, an urban development, a suburban development, a district, a utility district, a city, a county, or any combination thereof.
